(19) United States
(12) Patent Application Publication
(10) Pub. No.: US 2023/0259728 A1
(43) Pub. Date: Aug. 17, 2023

(54) LABELING SYSTEM

(71) Applicant: Hadran Advanced Labeling Solutions Ltd., Beit Ezra (IL)

(72) Inventor: Jaacov BITTON, Beit Ezra (IL)

(73) Assignee: Hadran Advanced Labeling Solutions Ltd., Beit Ezra (IL)

(21) Appl. No.: 17/672,741

(22) Filed: Feb. 16, 2022

(51) Int. Cl. G06K 7/10; G06Q 20/20; G06Q 10/08

(52) U.S. Cl. CPC G06K 7/10861; G06Q 20/203; G06Q 10/087; G06K 2007/10504

(57) ABSTRACT

A labeling system comprising a label applicator to apply a label of a plurality of labels on an object of a plurality of objects conveyed on a conveyor line, each label of said series of labels presenting a unique identifier, thereby uniquely labeling each of the objects of the plurality of objects; a sensor configured to sense the unique identifier presented on each of the plurality of label; and a processor configured to: obtain data relating to a characteristics feature for each of the plurality of the objects, obtain the sensed unique identifier from the sensor for each said plurality of, and save in a database data associating the unique identifier presented on the label on each of said plurality of objects with the characteristics feature of that object.

### FIELD OF THE INVENTION

The present invention relates to a labeling system for labeling conveyed objects with machine readable labels.

### BACKGROUND OF THE INVENTION

A labeling system for sequentially labeling objects conveyed in a row typically comprises a label reel and a label applicator. The label reel sequentially provides labels to the label applicator, and the label applicator applies a label to an object as that object passes adjacent to the label applicator. The label reel may include, for example, a reel cassette having a tape wound around the cassette, the tape carrying a sequential row of adhesive labels. The tape is advanced towards the label applicator, where a label peeler peels of a label at a time presenting it to the applicator. The label applicator then applies the peeled label onto the adjacent object of the objects.

A labeling system for labeling conveyed objects typically includes a synchronizer to synchronize the label applicator action with the movement of the conveyed objects (e.g., with the speed of the conveyor line carrying the objects). The synchronizer synchronizes between the arrival of an object to the vicinity of the label applicator and the operation of the label applicator so that the label applicator applies a label when the moving object in an appropriate distance from the label applicator.

Labels typically contain information about the labeled objects. For example, labels for products such as fruits or vegetables may indicate characteristics of the product such as size of the fruit or vegetable, information on the manufacturer (brand, address), or other specific information. Each characteristic of the objects may be classified into different classes that require a different label. For example, three types of labels may be required to indicate three sizes of an object (e.g., small, medium, and large). To label objects with different labels, multiple labeling apparatuses may be required, wherein each labeling apparatus applies labels from a reel of label with unique information. This in turn, may increase price, size, and handling complexity of the labeling system. Typically, when different types of labels are required, the different labels are provided on separate reels. The different labels are printed ahead of time on a label tape and each type of label is wrapped around a separate reel. The labels that are printed ahead of time are also referred to as pre-printed labels.

To reduce the number of label apparatuses needed in labeling systems with multiple types of labels, some labeling systems include a printer that prints on each label of a reel of blank labels the appropriate information just before that label is applied on the approaching object. For example, the printing head may print the letters S, M or L, or a machine-readable barcode or Quick Response (QR) code indicating the same, to indicate that the labeled object is either Small, Medium or Large. The printed information on the size of the fruit or vegetable may be read by a dedicated reader at a point of sale (POS) so that the appropriate price for that item is charged to the client at the POS. The printer is typically positioned juxtaposed to the label applicator. The printer may be required to print fast enough to avoid slowing down the line. A thermal printer, for example, is a relatively fast printer and is typically used in labeling systems requiring printing on demand. (POD). The thermal printer prints on special thermal printing labels coated with thermal ink, using temperature to activate the ink and turn it black. Printing on labels in labeling systems is referred to as Printing on Demand (POD). However, labeling systems with POD capabilities are typically slower than labeling systems with pre-printed labels. Furthermore, labeling systems with POD capabilities require printer maintenance and special labels.

### SUMMARY OF THE INVENTION

There is thus provided, in accordance with an embodiment of the invention, a labeling system that includes a label applicator to apply a label of a plurality of labels on an object of a plurality of objects conveyed on a conveyor line, each label of said series of labels presenting a unique identifier, thereby uniquely labeling each of the objects of the plurality of objects. The system may also include a sensor configured to sense the unique identifier presented on each of the plurality of label and a processor configured to obtain data relating to a characteristics feature for each of the plurality of the objects, to obtain the sensed unique identifier from the sensor of each said plurality of labels, and to save in a database data associating the unique identifier presented on the label on each of said plurality of objects with the characteristics feature of that object.

According to some embodiments of the invention, the sensor comprises an optical sensor.

According to some embodiments of the invention, the optical sensor is selected from the group of optical sensors consisting of: a camera, a barcode reader and a QR code reader.

According to some embodiments of the invention, the sensor comprises a sensor selected form the group of sensors consisting of: RF sensor, NFC sensor.

According to some embodiments of the invention, the label is a machine-readable label.

According to some embodiments of the invention, the unique identifier presented on the label in a form selected from the group of forms consisting of: barcode, QR code and RF tag.

According to some embodiments of the invention, the objects are fruits or vegetables.

According to some embodiments of the invention, the characteristic feature is selected from the group of characteristic features consisting of: size, quality, variety, age, and time lapsed since picking and expiration date.

According to some embodiments of the invention, the system further includes storage device to store the database.

According to some embodiments of the invention, the system further includes a communication module to communicate over a communication network with a remote device.

According to some embodiments of the invention, the remote device is a remote server, and wherein the communication module is configured to communicate the database to the remote server.

According to some embodiments of the invention, the system includes the remote device.

According to some embodiments of the invention, the remote device is configured to communicate with a point of sale querying about a unique identifier that was acquired from a label on an object at the point of sale, and to communicate to the point of sale the characteristics feature associated with of the unique identifier of that object, as saved in the database.

According to some embodiments of the invention, there is provided a system at a point of sale that includes a sensor for sensing a unique identifier presented on a label on an object, and a communication module to communicate with a remote server at which a database is stored, the database comprising data associating each of a plurality of unique identifiers with a characteristic feature of a plurality of characteristics features associated with objects labeled with labels carrying a unique identifier of said plurality of unique identifiers, and query about the sensed unique identifier to obtain a characteristic feature from the plurality of characteristics features associated of that unique identifier.

There is also provided, according to some embodiments of the invention, a labeling method that includes applying by a label applicator a label of a plurality of labels on an object of a plurality of objects conveyed on a conveyor line, each label of said series of labels presenting a unique identifier, thereby uniquely labeling each of the objects of the plurality of objects. The method may also include sensing by a sensor the unique identifier presented on each of the plurality of label. The method may also include using a processor to obtain data relating to a characteristic feature for each of the plurality of the objects, to obtain the sensed unique identifier from the sensor for each said plurality of labels and to save in a database data associating the unique identifier presented on the label on each of said plurality of objects with the characteristics feature of that object.

According to some embodiments of the invention, the method may also include facilitating communication between the remote server and a point of sale querying about a unique identifier that was acquired from a label on an object at the point of sale and communicating to the point of sale the characteristics feature associated with of the unique identifier of that object, as saved in the database.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1A is a side view of a labeling apparatus (prior art).

FIG. 1B is a top view of a labeling system, in accordance with some embodiments of the present invention.

FIG. 2 is a schematic view of a labeling system connected to a remote server that has a communication link with a POS, in accordance with some embodiments of the present invention.

FIG. 3 is a table associating unique identifiers with classes of characteristics of fruits, in accordance with some embodiments of the present invention.

FIG. 4 is flow chart of a method for labeling objects using a labeling system, in accordance with some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

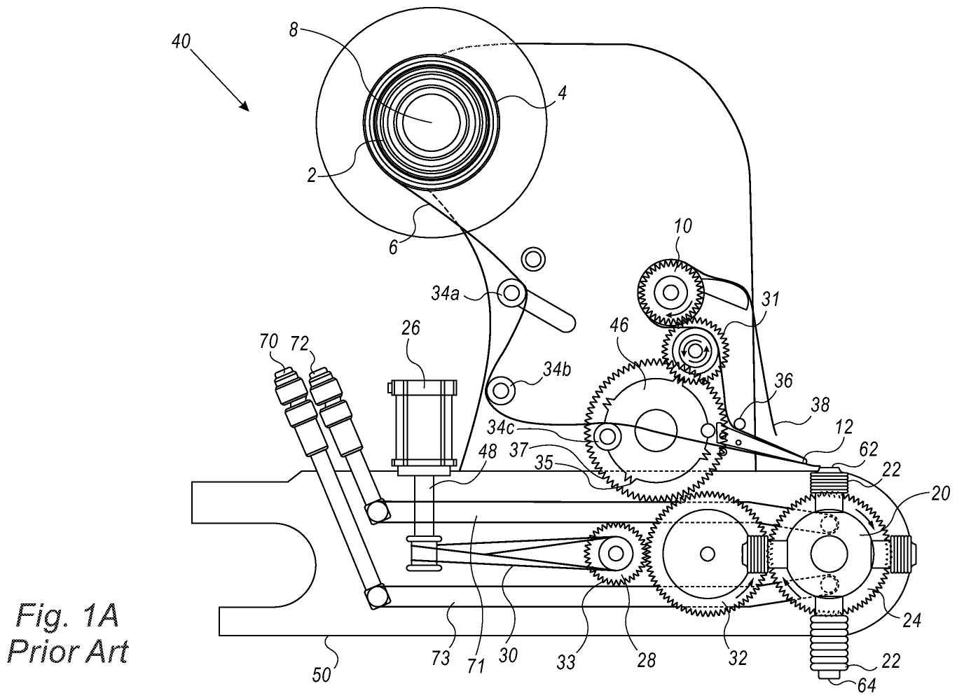

FIG. 1A is a side view of a labeling apparatus (prior art).

Labeling apparatus 40 may include a reel hub 8 with a label tape reel 2, on which a label tape 4 is wound, carrying a plurality of labels 6 arranged sequentially, each label 6 designed to be attached to an object to be labeled, as the object passes adjacent to the label applicator 24, and a label applicator 24 (here in the form of a revolving bellows head), configured to receive the label 6 at a label receiving position located at the tip of a peeler blade 12 and apply it onto the passing object.

The faces of labels 6 adjacent the carrier tape are coated with an adhesive layer. The label tape 4 is fed from the label reel 2 through optional guide rolls 34a, 34b, 34c, towards the peeling blade 12. Separation of each label of labels 6 from the label tape 4 occurs at the label receiving position, where label tape 4 is wound over a sharp end of the peeling blade 12 so that as label tape 4 advances label 6 is released from the label tape 4, at the label receiving position and is picked up by a bellow 22 of the label applicator 24, The label tape 4 is led away from peeling blade 12 through optional gear 31. Hauling gear 10 is provided to advance the tape, and to feed 38 the tape into an optional waste receiving bin, e.g., a basket, a waste container or an empty bobbin over which the tape is wound. The tension in the label carrier 4 is maintained for example, by a pressure roller 36.

Label applicator 24 includes a rotary application head 20 that carries a plurality of bellows 22.

The bellows 22 are each separately expandable and are typically equally spaced around the periphery of the rotary application head 20. The expandable feature of the bellows 22 enables the bellows to reach to objects of different sizes (heights). In order to contract the bellows 22 (for receiving the label 6) or to expand the bellows 22 (for applying the received label 6 to an object 42), each bellow 22 fluidly communicates via pipe 72 with a vacuum reservoir (when the bellows needs to be retracted) or via pipe 70 with a high-pressure air reservoir (when the bellow needs to be deployed to apply the label onto an object).

The reel hub 8 and label applicator 24 may be driven by a single common electric motor 26 which drives the reel hub 8 to supply labels 6 and at the same time drives the label applicator 24 to receive the next label of labels 6 and to apply that label the object below.

In order to facilitate simultaneous driving of both the bellows head 20 and the label tape 4, a transmission mechanism is provided, e.g., in the form of a set of cogs.

The set of cogs is designed to transmit the driving force of the motor to the bellows head 20 continuously and at the same time advance the label tape 4 at a rate of one label 6 per approaching bellow 22, which means that the speed of the advanced label tape 4 must be synchronized with the rotation of the bellows head in such a way that conforms with this requirement. For that aim the transmission mechanism includes a dual cog formation (see cog 46), or two coupled cogs, a first cog with a continuous formation of teeth on its circumference 37 and a second, concentric cog with a discrete non-continuous set of teeth distributed on its circumference 35 in a predetermined manner. The distribution of the discrete non-continuous set of teeth may be distributed evenly around the cog in groups, each group including one or more teeth, the number groups of teeth equal to the number of bellows. The even distribution of teeth groups around the second cog corresponds to the even distribution of labels on the label tape. As the dual cog formation 46 rotates the continuous formation of teeth along the circumference of the first cog turns the transmission cogs communicating continuously via optional transmission cogs with the bellows head 20, rotating it, whereas the discrete non-continuous set of teeth provided on the second cog communicates in a discrete manner via optional transmission cogs with the hauling wheel 10, the latter pulling the labels discretely and in a synchronized way with respect to the bellows head revolution.

The rest of the transmission mechanism shown in the drawings is only an example of transmission cog arrangement, and in no way is the only way of implementing the present invention.

The driving force of motor 26 is transmitted via drive belt 30 to a series of transmission cogs resulting in the rotation of the bellows head 20 and the simultaneous and synchronous advance of the label tape 4. The drive belt 30 extends around the output shaft 48 of the motor, which is vertically aligned, and wounds on roll 28 of cog 33. Rotation of the motor shaft 48 turns the roll 28 and its coupled cog 33 in the same direction. Cog 33 cooperates with cog 32 and turns it in the opposite direction.

Cog 32 communicates both with bellows head cog 24 and with the continuous cog teeth 37 of synchronization mechanism 35 here having a dual cog formation 46, turning both cogs in the same direction. As the dual cog formation 46 rotates, its discrete non-continuous set of teeth provided on the second cog 35 communicates in a discrete manner with hauling wheel 10 via transmission cog 31 and thus turns the hauling wheel in the opposite direction to the dual cog formation 46 pulling the label tape 4 from the label cassette 2. According to this transmission mechanism, as the motor is engaged, the bellows head rotates bellows 22 in a continuous manner, driving the bellows from label receiving position 62 to label applying position 64, while on the same time advancing label tape 4 at a rate of one label 6 per bellow 22.

The distances between each group of teeth on the second cog 35 of the dual cog formation 46 and the number of groups of teeth, as well as the radii ratio between the first cog and second cogs of the dual-cog formation determines the proper velocity of the label tape and the synchronization with the bellows head, so that each time label 6 is freed from the label tape 4 at the label receiving position 62, said label being picked up by a bellow 22. The dual cog formation 46, or only its second cog 35 having discrete non-continuous set of teeth, may be optionally replaceable to permit replacement with another cog in order to accommodate the labeling apparatus to labels of different sizes or distribution along the label tape.

An optional proximity sensor (preferably hidden within the bellows head or in its vicinity—not shown in the figures) communicating with the motor (optionally via a controller) is provided for detecting the presence or the absence of an object to be labeled near the bellows head. Once an object is detected by the proximity sensor, the motor 26 is engaged, thus, the bellows head rotates the bellows, turning the bellows sequentially from label receiving position 62 to label applying position 64 whereas at the label receiving position the bellow picks up a label and at the applying position the bellow sticks a label onto the object, while on the same time advancing the label tape 4 at a rate of one label 6 per bellow 22. The position of the proximity sensor is chosen with regard to the number of steps that the label applicator 20 takes between receiving a label by a bellow 22 and arriving of the bellow at the position where the bellow sticks the label onto an object 42.

The unique alignment of the labeling apparatus as described above and shown in the figures with the motor being positioned with its axis of rotation perpendicular to the cogs plane of rotation is important as it decreases the width of each labeling apparatus.

The motor shaft 48 is substantially vertical to the base 50. Due to this alignment, a compact multiple labeling apparatus can be constructed by providing side by side plurality of labeling apparatuses.

It may be appreciated by a person skilled in the art that labeling apparatus 40 or any similar labeling apparatus may be used for applying labels to objects (e.g., fruits and vegetables).

FIG. 1B is a top view of a labeling system, in accordance with some embodiments of the present invention. Labeling system 100 may be used for labeling a row of conveyed objects such as fruits and/or vegetables 110 by sequentially applying label 150 on each of the objects. Labeling system 100 may comprise one or a plurality of labeling apparatuses 40, each with a label applicator 142 for applying label 150 to each object 110 of a row 111 of conveyed objects. Each of the labeling apparatuses may include a label reel 144 carrying a label tape with row of pre-printed labels, each label carrying a unique identifier (e.g., a unique number), so that different labels on the label tape carry different identifiers.

Labeling system 100 may also include sensor 130 (e.g., imaging sensor, barcode reader, QR code reader), for reading label 150 and obtaining the unique identifier that is presented on label 150.

Labeling system 100 may also include a processor 160 configured to obtain data related to characteristics and classification of each objects110 of the row of objects conveyed towards labeling system 100, that may be provided, for example, by an inspection system upstream the row of objects, and to associate the unique identifier presented on label 150 that is applied to an object 110 with the provided characteristics of that object (e.g., small, medium, or large). Storage device 162 (e.g., hard disk) may be used to store the data associating each unique identifier on each of the labels with the characteristics of the object on which the label with that unique identifier was applied. Communication module 164 may be provided to communicate the stored data to a remote device or devices via a communication network.

Labeling system 100 may be used in facilities for packaging and labeling fresh produce such as fruits, vegetables and the like. Fruit may have multiple significant characteristics, said characteristics may be reflected in the pricing of that fruit. For example, characteristics such as variety, age, lapsed time since picking, size and quality of the fruit may determine pricing of that fruit. Each characteristic of the fruit may have a plurality of classes rating the fruit 110. For example, size characteristic of fruits may relate to the following classes: small, medium, large and extra-large. A fruit of medium size may be priced lower than a fruit of a large size.

In some embodiments of the present invention, labeling system 100 may associate the unique identifier presented on label 150 with a class of a plurality of classes related to a characteristic of a plurality of characteristics of object 110. a database associating between fruit 110 and characteristics and classification thereof may be stored on storage device 162 and/or communicated using the communication module 164 to a remote device. The database may be made accessible by vendors and stores selling object 110. When label 150 of object 110 is scanned in a store (e.g., at a point of sale at a cashier of the store when checking out), the unique identifier presented on label 150 may be read by a sensor such as a barcode or QR code scanner at the store. A computing system of the store may obtain the sensed unique identifier from the sensor at the store and access the remote database for acquiring the characteristics data of object 110 associated with the unique identifier on label 160. The computing system of the store may then determine the price of object 110 based on the acquired data (obtained from the remote database).

In some embodiments of the present, label applicator 142 may apply label 150 to fruit 110 on conveyor line 120.

In some embodiments of the present invention label 150 may present an identifier such as a symbol, code, number, combination of colors or image.

In some embodiments of the present invention, label 150 may present a unique identifier in a barcode format. For example, each unique identifier may present a barcode with a different number. Sequential numbers may be presented on barcodes of sequential labels.

In some embodiments of the present invention, label 150 may present a unique identifier in a two-dimensional barcode format such as a QR code format. For example, each unique identifier may present a QR code with a unique number (e.g., sequential labels may have sequential QR codes). Sensor 130 may sense the unique identifier presented by the QR code on label 150. For example, sensor 130 may be an optical sensor such as a camera or a QR code scanner.

In some embodiments of the present invention, label 150 may comprise a Radio Frequency (RF) tag such as a Near-Field Communication (NFC) tag. The RF tag may have a code or encryption defining a unique identifier for each label of the series of labels. Sensor 130 may sense the unique identifier presented by the RF tag of label 150. For example, sensor 130 may be a RF transceiver such as an RF tag reader or an NFC tag reader.

In some embodiments of the present invention, labeling system 100 may include a printer for printing a unique identifier on the labels. For example, the printer may be positioned close to the conveyor line 120 and pointed at object 110. The printer head may comprise a laser device for engraving a unique identifier on object 110.

In some embodiments of the present invention, sensor 130 may sense the unique identifier presented on label 150 before during or after label 150 is applied to object 110. Sensor 130 may be positioned near label applicator 142 or reel 144. Sensor 130 may be pointed at the label tape, label applicator 142 or at any position on labeling system 100 to sense the unique identifier presented on label 150 before, during or after label 150 is applied to object 110.

In some embodiments of the present invention, labeling system 100 may label one or a plurality of objects (e.g., fruits, vegetables) placed in a box such as a wooden crate, pallet bin, wire bound crate, paper or carton box and lug box. A plurality of objects may be placed in a box, wherein the box may be placed on a moving conveyor line 120. Labeling system 100 may label objects 110 inside the box while the box is moving along the conveyor line 120. In some embodiments of the present invention, labeling system 100 may apply a label to a box containing a plurality of fruits and the fruits within said box. For example, labeling system 100 may apply one or a plurality of labels at least one of which presents a unique identifier (such as an ID or a serial number) to a box containing one or a plurality of fruits within said box. The box may be closed or partially closed. The box may be wrapped or covered with a wrapper or a cover (e.g., plastic wrapping), the labeling system 100 may apply a label on the wrapper or cover of the box.

In some embodiments of the present invention, processor 160 may directly obtain data related to a characteristic of the plurality of fruits 110, classifying each of said plurality of fruits 110 in one of a plurality of classes of said characteristic, for example by using a dedicated detection system. In some embodiments of the present invention, processor 160 may obtain data relating to the objects 110 from a sorting system and/or a classifying system. Said sorting system and/or classifying system may sort and/or classify the objects 110 before the objects 110 are labeled. The sorting system and/or classifying system may send data related to the sorted and/or classified fruits to the processor 160. The processor may then associate between the unique identifier presented on label 150 applied to object 110 and data (such as characteristics and classification) of object 110. In other embodiments of the present invention, labeling system 100 may obtain data related to objects 110 from sensors (such as sensor 130) of labeling system 100. Sensor 130 may comprise sensors capable of classifying object 110. For example, sensor 130 may comprise a camera for obtaining an image of object 110. Using the image of object 110 the processor 160 may classify characteristics of object 110 such as size of object 110. The processor 160 may determine size of object 110 (e.g., size of object 110 is small, medium or large) based on images of object 110.

In some embodiments of the present invention, one or a plurality of characteristics of object 110 may obtained by processor 110. Processor 160 may obtain characteristics of object 110 such as, in the case of fruits (or vegetables), the size of the fruit, quality of the fruit, expiration date of the fruit, origin of the fruit (e.g., where fruit 110 was grown), taste grading and chemical properties of the fruit (e.g., sugar content, starchiness, acidity), type and species of the fruit, data related to treatment and cultivation of fruit 110 (e.g., pesticide treatment, if fruit 110 was grown organically, if fruit 110 was grown using artificial irrigation or natural irrigation, if fruit 110 was grown in an artificial environment, such as a greenhouse, or naturally, such as in an open field), defects and imperfections of fruit 110, data relating to harvesting conditions of fruit 110 (e.g., season and date of harvest, if fruit 110 was hand harvested or machine harvested), and standardized grading of fruit 110 (e.g., governmental standard for grading fresh produce). major types of characteristics and classifications.

In some embodiments of the present invention, processor 160 may obtain data related to classes of characteristics of object 110 and/or grading of characteristics of object 110. Processor 160 may obtain data related to size characterization classes of object 110 such as small size, medium size, large size, extra-large size. Processor 160 may obtain data related to quality characterization classes and standardized grading of object 110 such as low quality, medium quality, high quality and premium quality. For another example, processor 160 may obtain an alpha numerical grading of object 110 such as A for highest quality and F for lowest quality.

In some embodiments of the present invention, processor 160 may send data associating object 110, characteristics of object 110 and classes of characteristics of object 110 with a unique identifier presented on label 150 applied to object 110 to a remote server. Users such as cashiers, retailers, and persons of interest (e.g., a person who bought object 110) may access said data. For example, a user wanting to find data related to characteristics of object 110 may access the data related to object 110 on the remote server. The user may query the data related to object 110 using the unique identifier presented on object 110 (e.g., via a computer program interface or an application). In some embodiments of the present invention, data related to object 110 may be obtained by a user for pricing object 110. For example, when object 110 with label 150 is scanned at a store checkout system, a computing system of the store may access data related to object 110 on the remote server for estimating price of object 110 based on said data (e.g., size and quality of the object 110 may increase the price thereof).

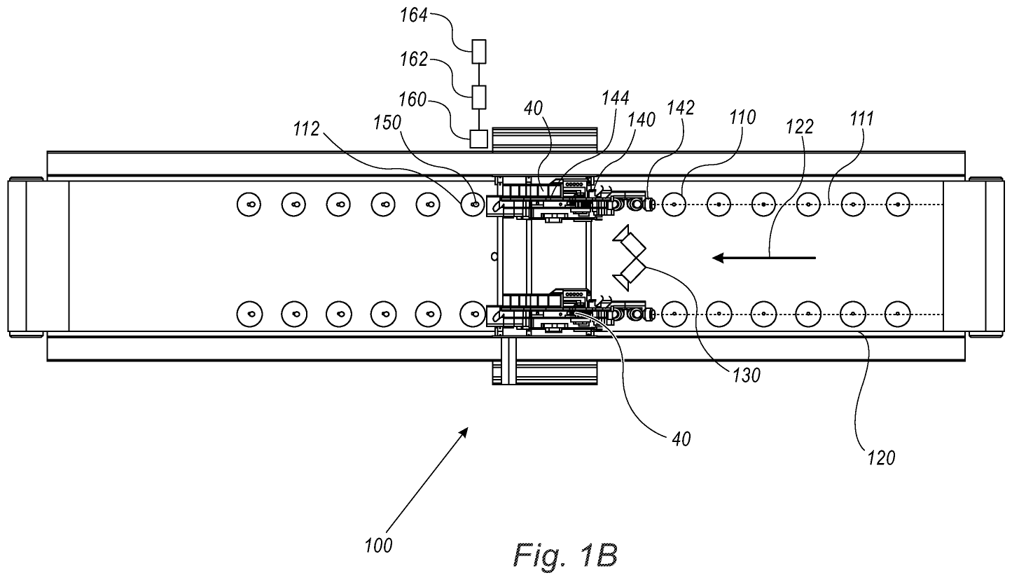

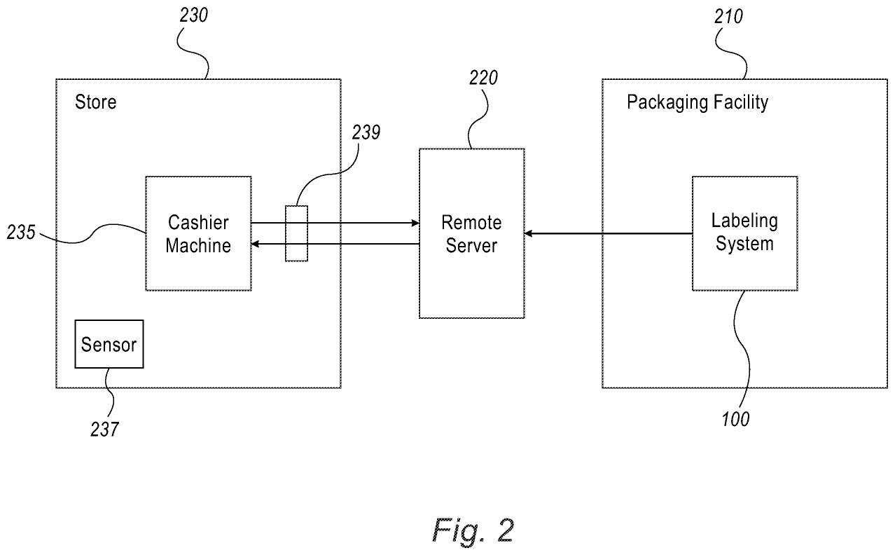

FIG. 2 is a schematic view of a labeling system connected to a remote server that is connected to a shop, in accordance with some embodiments of the present invention. Labeling system 100 may be placed in a facility for sorting, packaging, storing and/or labeling fruits and vegetables such as packaging facility 210. A plurality of fruits may be sorted and labeled in packaging facility 210. Labeling system 100 may associate between data related to the fruits and the labels applied to the fruits (e.g., the unique identifiers presented on the labels). Labeling system 100 may send data associating unique identifiers presented on the labels with characteristics of the fruits to remote server 220. Labeling system 100 may create a data structure such as a lookup table (such as table 300 of FIG. 3), SQL database, NON-SQL database and similar data structures with data related to characteristics of each fruit associated with the unique identifier of the fruit.

In some embodiments of the present invention, store 230 may have a cashier machine 235 with computing capabilities and connection to the remote server 220. Cashier machine 235 may obtain a scan of a label on a fruit in store 230 for pricing said fruit. For example, cashier machine 235 may have a sensor 237 for scanning the label. Cashier machine 235 may communicate via a communication module 239 with a remote server 220 and obtain data from a database stored on remote sever 220 for associating between the unique identifier presented on the label and characteristics of the fruit for pricing the fruit (e.g., size classification of the fruit).

In some embodiments of the present invention, a user such as a cashier or a person purchasing a fruit may query the database of remote server 220 using a user interface via an application (e.g., on a digital device of the user such as a smartphone or a smart device) or an interface on a computer of the store (e.g., a display screen connected to a computer with access to server 220). The user may obtain data related to the fruit by querying server 220 using the unique identifier presented on the label applied to the fruit.

FIG. 3 is a table presenting a database associating unique identifiers with classes of characteristics of fruits, in accordance with some embodiments of the present invention. Table 300 may contain data associating unique identifiers with data related to characteristics and classification of fruits. Table 300 may be stored on a remote server so that a user may access data related to a fruit by querying the unique identifier presented on the label applied to said fruit. A labeling system may also query table 300 for entering new entries to table 300. The labeling system may communicate with the remote server and send data associating between a new unique identifier and characteristics and classification of a fruit that has a label with said new unique identifier.

In some embodiments of the present invention, data table 300 may contain at least data regarding unique identifiers. For example, data table 300 may contain a column with all the unique identifiers said column may act as a key column for querying table 300.

In some embodiments of the present invention, table 300 may contain data related to characteristics of fruits. Data table 300 may contain a column with classification of size characteristics. The column of the size characteristics many contain classification of each unique identifier related to size of the fruit with the label having said unique identifier. For example, a fruit with a label having the unique identifier 10004 may have a medium class in the size characteristics.

In some embodiments of the present invention, table 300 may contain a column with classification of quality characteristics (e.g., standard or governmental grading of fruits). The column of the quality characteristics many contain classification of each unique identifier related to quality of the fruit with the label having said unique identifier. For example, a fruit with a label having the unique identifier 10005 may have a premium class in the quality characteristics.

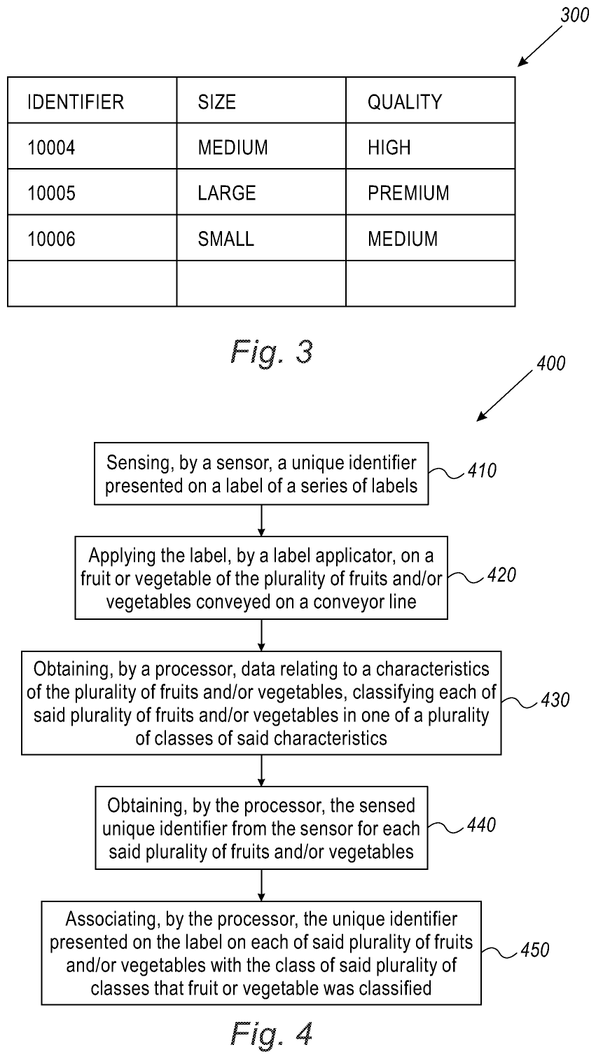

FIG. 4 is flow chart of a method for labeling objects using a labeling system, in accordance with some embodiments of the present invention. Method 400 for labeling fruits and/or vegetables using a labeling system (such as labeling system 100 of FIG. 1) may comprise sensing, by a sensor, a unique identifier presented on a label of a series of labels 410.

In some embodiments of the present invention, method 400 may comprise applying the label, by a label applicator, on a fruit or vegetable of the plurality of fruits and/or vegetables conveyed on a conveyor line 420.

In some embodiments of the present invention, method 400 may comprise obtaining, by a processor, data relating to a characteristic of the plurality of fruits and/or vegetables, classifying each of said plurality of fruits and/or vegetables in one of a plurality of classes of said characteristics 430.

In some embodiments of the present invention, method 400 may comprise obtaining, by the processor, the sensed unique identifier from the sensor for each said plurality of fruits and/or vegetables 440.

In some embodiments of the present invention, method 400 may comprise associating, by the processor, the unique identifier presented on the label on each of said plurality of fruits and/or vegetables with the class of said plurality of classes that fruit or vegetable was classified 450.

In some embodiments of the present invention, method 400 may comprise creating, by the processor, a lookup table for associating between the unique identifier presented on the label on each of said plurality of fruits and/or vegetables with the class of said plurality of classes that fruit or vegetable was classified.

In some embodiments of the present invention, method 400 may comprise sending, by the processor, data associating between the unique identifier presented on the label on each of said plurality of fruits and/or vegetables with the class of said plurality of classes that fruit, or vegetable was classified, to a remote server.

Different embodiments are disclosed herein. Features of certain embodiments may be combined with features of other embodiments. Thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A labeling system comprising:
a label applicator to apply a label of a plurality of labels on an object of a plurality of objects conveyed on a conveyor line, each label of said series of labels presenting a unique identifier, thereby uniquely labeling each of the objects of the plurality of objects;
a sensor configured to sense the unique identifier presented on each of the plurality of label; and
a processor configured to:
obtain data relating to a characteristic feature for each of the plurality of the objects,
obtain the sensed unique identifier from the sensor for each said plurality of, and
save in a database data associating the unique identifier presented on the label on each of said plurality of objects with the characteristics feature of that object.

2. The system of claim 1, wherein the sensor comprises an optical sensor.

3. The system of claim 2, wherein the optical sensor is selected from the group of optical sensors consisting of: a camera, a barcode reader and a QR code reader.

4. The system of claim 1, wherein the sensor comprises a sensor selected form the group of sensors consisting of: RF sensor, NFC sensor.

5. The system of claim 1, wherein the label is a machine-readable label.

6. The system of claim 5, wherein the unique identifier presented on the label in a form selected from the group of forms consisting of: barcode, QR code and RF tag.

7. The system of claim 1, wherein the objects are fruits or vegetables.

8. The system of claim 7, wherein the characteristic feature is selected from the group of characteristic features consisting of: size, quality, variety, age, and time lapsed since picking and expiration date.

9. The system of claim 1, further comprising storage device to store the database.

10. The system of claim 1, further comprising a communication module to communicate over a communication network with a remote device.

11. The system of claim 10, wherein the remote device is a remote server, and wherein the communication module is configured to communicate the database to the remote server.

12. The system of claim 11, comprising the remote device.

13. The system of claim 12, wherein the remote device is configured to communicate with a point of sale querying about a unique identifier that was acquired from a label on an object at the point of sale, and to communicate to the point of sale the characteristics feature associated with of the unique identifier of that object, as saved in the database.

14. A system at a point of sale comprising:
a sensor for sensing a unique identifier presented on a label on an object
a communication module to communicate with a remote server at which a database is stored, the database comprising data associating each of a plurality of unique identifiers with a characteristic feature of a plurality of characteristics features associated with objects labeled with labels carrying a unique identifier of said plurality of unique identifiers, and query about the sensed unique identifier to obtain a characteristic feature from the plurality of characteristics features associated of that unique identifier.

15. A labeling method comprising:
applying by a label applicator a label of a plurality of labels on an object of a plurality of objects conveyed on a conveyor line, each label of said series of labels presenting a unique identifier, thereby uniquely labeling each of the objects of the plurality of objects;
sensing by a sensor the unique identifier presented on each of the plurality of label; and
using a processor:
obtaining data relating to a characteristic feature for each of the plurality of the objects,
obtaining the sensed unique identifier from the sensor for each said plurality of labels, and
saving in a database data associating the unique identifier presented on the label on each of said plurality of objects with the characteristics feature of that object.

16. The method of claim 15, wherein the sensor is selected from the group of sensors consisting of: a camera, a barcode reader, a QR code reader, RF sensor and NFC sensor.

17. The method of claim 15, wherein the objects are fruits or vegetables.

18. The method of claim 17, wherein the characteristic feature is selected from the group of characteristic features consisting of: size, quality, variety, age, and time lapsed since picking, expiration date.

19. The method of claim 14, further comprising communicate the database to a remote server.

20. The method of claim 19, further comprising facilitating communication between the remote server and a point of sale querying about a unique identifier that was acquired from a label on an object at the point of sale and communicating to the point of sale the characteristics feature associated with of the unique identifier of that object, as saved in the database.
